(19) United States
(12) Patent Application Publication
(10) Pub. No.: US 2025/0261079 A1
(43) Pub. Date: Aug. 14, 2025

(54) METHOD, APPARATUS AND COMPUTER PROGRAM

(71) Applicant: Nokia Technologies Oy, Espoo (FI)

(72) Inventors: Pallab GUPTA, Bangalore (IN); Laurent THIÉBAUT, Massy (FR); Shubhranshu SINGH, Munich (DE)

(21) Appl. No.: 18/865,054

(22) PCT Filed: May 16, 2023
(86) PCT No.: PCT/EP2023/063044

§ 371 Date: Nov. 12, 2024

(30) Foreign Application Priority Data
May 16, 2022 (IN) 202211028014

(51) Int. Cl. H04W 40/02

(52) U.S. Cl. CPC H04W 40/02

(57) ABSTRACT

There is provided an apparatus in a user equipment, the apparatus comprising: means for receiving, from a core network entity, at least one user equipment route selection policy rule, wherein the at least one user equipment route selection policy rule comprises a component with information associated with a source device that is able to request data traffic via the user equipment, and means for receiving, from an application of the source device, a request for uplink data traffic, wherein the request comprises information about the source device. The apparatus further comprising means for determining how to route the data traffic from the application, using the at least one user equipment route selection policy rule and based on the received information about the source device in the request, to determine a route, and means for routing the data traffic according to the determined route.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus in a user equipment, the apparatus comprising: means for receiving, from a core network entity, at least one user equipment route selection policy rule, wherein the at least one user equipment route selection policy rule comprises a component with information associated with a source device that is able to request data traffic via the user equipment; means for receiving, from an application of the source device, a request for uplink data traffic, wherein the request comprises information about the source device; means for determining how to route the data traffic from the application, using the at least one user equipment route selection policy rule and based on the received information about the source device in the request, to determine a route; and means for routing the data traffic according to the determined route.

In an example, the user equipment is configured as a gateway for the device.

In an example, the information that identifies at least one source application is comprised within a traffic descriptor component of the user equipment route selection policy rule.

In an example, for the at least one user equipment route selection policy rule, the information associated with the source device comprises at least one of: an identity of at least one source device; an identity of a network associated with the user equipment.

In an example, at least one of: the identity of the source device is an identity of a personal internet-of-things network element; and the identity of the network is an identity of a personal internet-of-things network.

In an example, the identity of the source device comprises at least one of: a MAC address, a source IP address, a port number, a Bluetooth identity, a unique identification of the PINE, a network access identifier received by the user equipment once the source device has been authenticated.

In an example, the identity of a personal internet-of-things network comprises at least one of: an SSID of an access point, a unique identification of the PIN.

In an example, the at least one user equipment route selection policy rule comprises a plurality of user equipment route selection policy rules, and wherein the means for determining comprises: means for comparing i) the received information about the source device in the request, with ii) the respective information within the components of each of the plurality of user equipment route selection policy rules; and means for selecting a user equipment route selection policy rule of the plurality of user equipment route selection policy rules, based on the comparing.

In an example, the means for comparing the received information about the source device in the request with the respective information within the components of each of the plurality of user equipment route selection policy rules comprises: means for matching the received information about the source device with respective information within the components of each of the plurality of user equipment route selection policy rules.

In an example, the route is determined utilising a route selection descriptor associated with the selected user equipment route selection policy rule.

In an example, the apparatus comprises: means for determining whether there is an existing protocol data unit session that has been established and is compatible with the route selection descriptor; and means for, when there is an existing protocol data unit session that is compatible with the route selection descriptor, utilising the protocol data unit session for routing the data traffic.

In an example, the apparatus comprises: means for performing quality of service mapping, for the protocol data unit session, using at least one quality of service rule.

In an example, the user equipment is configured as a gateway for a personal internet-of-things network, the personal internet-of-things network comprising at least one personal internet-of-things network element.

In an example, the apparatus comprises: means for providing an indication, to a further core network entity, that the user equipment supports user equipment route selection policy rules with components that have information associated with a source device that is able to request data traffic via a user equipment.

In an example, the indication is provided to the further core network entity within a registration request message.

According to an aspect, there is provided an apparatus for a core network entity, the apparatus comprising: means for determining, for a user equipment, at least one user equipment route selection policy rule, wherein the at least one user equipment route selection policy rule comprises a component with information associated with a source device that is able to request data traffic via the user equipment; and means for providing, to the user equipment, the at least one user equipment route selection policy rule.

In an example, for the at least one user equipment route selection policy rule, the information associated with the source device comprises at least one of: an identity of at least one source device; an identity of a network associated with the user equipment.

In an example, at least one of: the identity of the source device is an identity of a personal internet-of-things network element; and the identity of the network is an identity of a personal internet-of-things network.

In an example, the identity of the source device comprises at least one of: a MAC address, a source IP address, a port number, a Bluetooth identity, a unique identification of the PINE, a network access identifier received by the user equipment once the source device has been authenticated.

In an example, the identity of a personal internet-of-things network comprises at least one of: an SSID of an access point, a unique identification of the PIN.

In an example, the means for determining comprises means for determining the at least one user equipment route selection policy rule based on a received input from an application function, wherein the application function is associated with a personal internet-of-things network associated with the user equipment device.

In an example, the apparatus comprises: means for receiving an indication, from the user equipment, that the user equipment supports user equipment route selection policy rules with components that have information associated with a source device that is able to request data traffic via a user equipment.

In an example, the apparatus comprises: means for using the received indication to trigger the determination of the at least one user equipment route selection policy rule which comprises the component with information associated with the source device that is able to request data traffic via the user equipment.

According to an aspect, there is provided an apparatus comprising: one or more processors, and memory storing instructions that, when executed by the one or more processors, cause the apparatus to perform: receiving, from a core network entity, at least one user equipment route selection policy rule, wherein the at least one user equipment route selection policy rule comprises a component with information associated with a source device that is able to request data traffic via the user equipment; receiving, from an application of the source device, a request for uplink data traffic, wherein the request comprises information about the source device; determining how to route the data traffic from the application, using the at least one user equipment route selection policy rule and based on the received information about the source device in the request, to determine a route; and routing the data traffic according to the determined route.

In an example, the user equipment is configured as a gateway for the device.

In an example, the information that identifies at least one source application is comprised within a traffic descriptor component of the user equipment route selection policy rule.

In an example, for the at least one user equipment route selection policy rule, the information associated with the source device comprises at least one of: an identity of at least one source device; an identity of a network associated with the user equipment.

In an example, at least one of: the identity of the source device is an identity of a personal internet-of-things network element; and the identity of the network is an identity of a personal internet-of-things network.

In an example, the identity of the source device comprises at least one of: a MAC address, a source IP address, a port number, a Bluetooth identity, a unique identification of the PINE, a network access identifier received by the user equipment once the source device has been authenticated.

In an example, the identity of a personal internet-of-things network comprises at least one of: an SSID of an access point, a unique identification of the PIN.

In an example, the at least one user equipment route selection policy rule comprises a plurality of user equipment route selection policy rules, and wherein the determining comprises: comparing i) the received information about the source device in the request, with ii) the respective information within the components of each of the plurality of user equipment route selection policy rules; and selecting a user equipment route selection policy rule of the plurality of user equipment route selection policy rules, based on the comparing.

In an example, the comparing the received information about the source device in the request with the respective information within the components of each of the plurality of user equipment route selection policy rules comprises: matching the received information about the source device with respective information within the components of each of the plurality of user equipment route selection policy rules.

In an example, the route is determined utilising a route selection descriptor associated with the selected user equipment route selection policy rule.

In an example, the apparatus is caused to perform: determining whether there is an existing protocol data unit session that has been established and is compatible with the route selection descriptor; and when there is an existing protocol data unit session that is compatible with the route selection descriptor, utilising the protocol data unit session for routing the data traffic.

In an example, the apparatus is caused to perform: performing quality of service mapping, for the protocol data unit session, using at least one quality of service rule.

In an example, the user equipment is configured as a gateway for a personal internet-of-things network, the personal internet-of-things network comprising at least one personal internet-of-things network element.

In an example, the apparatus is caused to perform: providing an indication, to a further core network entity, that the user equipment supports user equipment route selection policy rules with components that have information associated with a source device that is able to request data traffic via a user equipment.

In an example, the indication is provided to the further core network entity within a registration request message.

According to an aspect, there is provided an apparatus comprising: one or more processors, and memory storing instructions that, when executed by the one or more processors, cause the apparatus to perform: determining, for a user equipment, at least one user equipment route selection policy rule, wherein the at least one user equipment route selection policy rule comprises a component with information associated with a source device that is able to request data traffic via the user equipment; and providing, to the user equipment, the at least one user equipment route selection policy rule.

In an example, for the at least one user equipment route selection policy rule, the information associated with the source device comprises at least one of: an identity of at least one source device; an identity of a network associated with the user equipment.

In an example, at least one of: the identity of the source device is an identity of a personal internet-of-things network element; and the identity of the network is an identity of a personal internet-of-things network.

In an example, the identity of the source device comprises at least one of: a MAC address, a source IP address, a port number, a Bluetooth identity, a unique identification of the PINE, a network access identifier received by the user equipment once the source device has been authenticated.

In an example, the identity of a personal internet-of-things network comprises at least one of: an SSID of an access point, a unique identification of the PIN.

In an example, the determining comprises determining the at least one user equipment route selection policy rule based on a received input from an application function, wherein the application function is associated with a personal internet-of-things network associated with the user equipment device.

In an example, the apparatus is caused to perform: receiving an indication, from the user equipment, that the user equipment supports user equipment route selection policy rules with components that have information associated with a source device that is able to request data traffic via a user equipment.

In an example, the apparatus is caused to perform: using the received indication to trigger the determination of the at least one user equipment route selection policy rule which comprises the component with information associated with the source device that is able to request data traffic via the user equipment.

According to an aspect, there is provided a method performed by a user equipment, the method comprising: receiving, from a core network entity, at least one user equipment route selection policy rule, wherein the at least one user equipment route selection policy rule comprises a component with information associated with a source device that is able to request data traffic via the user equipment; receiving, from an application of the source device, a request for uplink data traffic, wherein the request comprises information about the source device; determining how to route the data traffic from the application, using the at least one user equipment route selection policy rule and based on the received information about the source device in the request, to determine a route; and routing the data traffic according to the determined route.

In an example, the user equipment is configured as a gateway for the device.

In an example, the information that identifies at least one source application is comprised within a traffic descriptor component of the user equipment route selection policy rule.

In an example, for the at least one user equipment route selection policy rule, the information associated with the source device comprises at least one of: an identity of at least one source device; an identity of a network associated with the user equipment.

In an example, at least one of: the identity of the source device is an identity of a personal internet-of-things network element; and the identity of the network is an identity of a personal internet-of-things network.

In an example, the identity of the source device comprises at least one of: a MAC address, a source IP address, a port number, a Bluetooth identity, a unique identification of the PINE, a network access identifier received by the user equipment once the source device has been authenticated.

In an example, the identity of a personal internet-of-things network comprises at least one of: an SSID of an access point, a unique identification of the PIN.

In an example, the at least one user equipment route selection policy rule comprises a plurality of user equipment route selection policy rules, and wherein the determining comprises: comparing i) the received information about the source device in the request, with ii) the respective information within the components of each of the plurality of user equipment route selection policy rules; and selecting a user equipment route selection policy rule of the plurality of user equipment route selection policy rules, based on the comparing.

In an example, the comparing the received information about the source device in the request with the respective information within the components of each of the plurality of user equipment route selection policy rules comprises: matching the received information about the source device with respective information within the components of each of the plurality of user equipment route selection policy rules.

In an example, the route is determined utilising a route selection descriptor associated with the selected user equipment route selection policy rule.

In an example, the method comprises: determining whether there is an existing protocol data unit session that has been established and is compatible with the route selection descriptor; and when there is an existing protocol data unit session that is compatible with the route selection descriptor, utilising the protocol data unit session for routing the data traffic.

In an example, the method comprises: performing quality of service mapping, for the protocol data unit session, using at least one quality of service rule.

In an example, the user equipment is configured as a gateway for a personal internet-of-things network, the personal internet-of-things network comprising at least one personal internet-of-things network element.

In an example, the method comprises: providing an indication, to a further core network entity, that the user equipment supports user equipment route selection policy rules with components that have information associated with a source device that is able to request data traffic via a user equipment.

In an example, the indication is provided to the further core network entity within a registration request message.

According to an aspect, there is provided a method performed by a core network entity, the method comprising: determining, for a user equipment, at least one user equipment route selection policy rule, wherein the at least one user equipment route selection policy rule comprises a component with information associated with a source device that is able to request data traffic via the user equipment; and providing, to the user equipment, the at least one user equipment route selection policy rule.

In an example, for the at least one user equipment route selection policy rule, the information associated with the source device comprises at least one of: an identity of at least one source device; an identity of a network associated with the user equipment.

In an example, at least one of: the identity of the source device is an identity of a personal internet-of-things network element; and the identity of the network is an identity of a personal internet-of-things network.

In an example, the identity of the source device comprises at least one of: a MAC address, a source IP address, a port number, a Bluetooth identity, a unique identification of the PINE, a network access identifier received by the user equipment once the source device has been authenticated.

In an example, the identity of a personal internet-of-things network comprises at least one of: an SSID of an access point, a unique identification of the PIN.

In an example, the determining comprises determining the at least one user equipment route selection policy rule based on a received input from an application function, wherein the application function is associated with a personal internet-of-things network associated with the user equipment device.

In an example, the method comprises: receiving an indication, from the user equipment, that the user equipment supports user equipment route selection policy rules with components that have information associated with a source device that is able to request data traffic via a user equipment.

In an example, the method comprises: using the received indication to trigger the determination of the at least one user equipment route selection policy rule which comprises the component with information associated with the source device that is able to request data traffic via the user equipment.

According to an aspect, there is provided a computer program comprising computer executable instructions which when run on one or more processors perform: receiving, from a core network entity, at least one user equipment route selection policy rule, wherein the at least one user equipment route selection policy rule comprises a component with information associated with a source device that is able to request data traffic via the user equipment; receiving, from an application of the source device, a request for uplink data traffic, wherein the request comprises information about the source device; determining how to route the data traffic from the application, using the at least one user equipment route selection policy rule and based on the received information about the source device in the request, to determine a route; and routing the data traffic according to the determined route.

According to an aspect, there is provided a computer program comprising computer executable instructions which when run on one or more processors perform: determining, for a user equipment, at least one user equipment route selection policy rule, wherein the at least one user equipment route selection policy rule comprises a component with information associated with a source device that is able to request data traffic via the user equipment; and providing, to the user equipment, the at least one user equipment route selection policy rule. A computer product stored on a medium may cause an apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### List of Abbreviations

AF Application Function
AMF: Access Management Function
AN: Access Network
ANDSP: Access Network Discovery and Selection Policy
BS: Base Station
CN: Core Network
DL: Downlink
eNB: eNodeB
gNB: gNodeB
IoT: Internet of Things
IIoT: Industrial Internet of Things
LTE: Long Term Evolution
NEF: Network Exposure Function
NG-RAN: Next Generation Radio Access Network
NF: Network Function
NR: New Radio
NRF: Network Repository Function
NW: Network
MS: Mobile Station
PCF Policy Control Function
PEGC: PIN Element with Gateway Capability
PEMC: PIN Element with Management Capability
PIN: Personal IoT Network
PINE: PIN Element
PLMN: Public Land Mobile Network
RAN: Radio Access Network
RF: Radio Frequency
SMF: Session Management Function
SSID: Service Set Identifier
UE: User Equipment
UDR: Unified Data Repository
UDM: Unified Data Management
UL: Uplink
UPF: User Plane Function
URSP: User Equipment Route Selection Policy
3GPP: 3^{rd} Generation Partnership Project
5G: 5^{th} Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of an example personal internet-of-things network;

FIG. 5 shows an example signalling diagram between a user equipment and network entities;

FIG. 6 shows another example signalling diagram between a user equipment and network entities;

FIG. 7 shows an example method flow diagram performed by a user equipment;

FIG. 8 shows an example method flow diagram performed by a network entity; and

FIG. 9 shows a schematic representation of a non-volatile memory medium storing instructions which when executed by a processor allow a processor to perform one or more of the steps of the method of FIG. 7 or 8.

### DETAILED DESCRIPTION

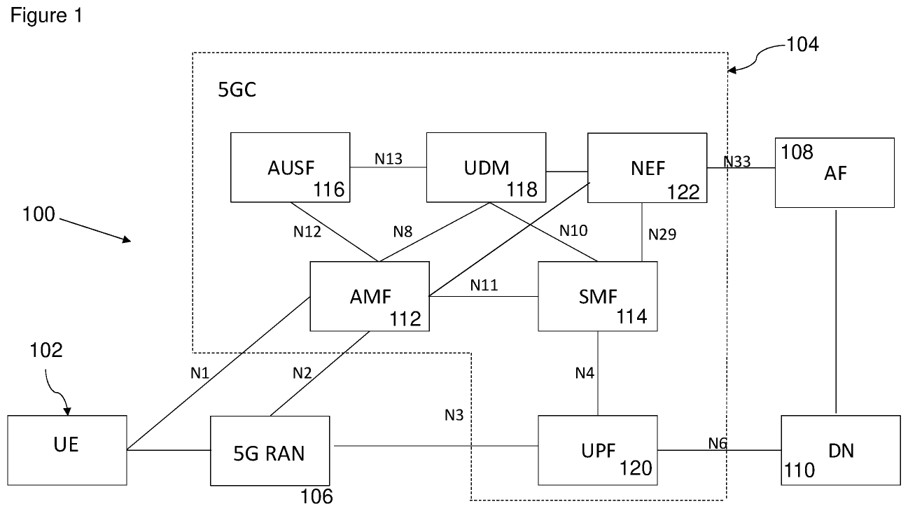

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of disclose, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS) 100. The 5GS may comprises a device 102 such as user equipment or terminal, a 5G access network (5G-AN) 106, a 5G core network (5GC) 104, one or more network functions (NF), one or more application function (AF) 108 and one or more data networks (DN) 110.

The 5G-AN 106 may comprise one or more gNodeB (gNB) distributed unit functions connected to one or more gNodeB (gNB) centralized unit functions. Even though one or more of the following examples refer to 5G RAN and gNodeB (gNB), the mechanisms described are not restricted to 5G access networks (5G-AN) as they are also applicable to UEs that are connected to the 5GC 104 via a non-3GPP interworking function (N3IWF) for un-trusted access to 5GC, a trusted non-3GPP gateway function (TNGF) for trusted access to 5GC, or a wireless access gateway function (W-AGF) for wireline access to 5GC,

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 4G, 3G and other 3GPP standards.

In a communication system, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a station or access point, and transmit and/or receive communications on the carrier.

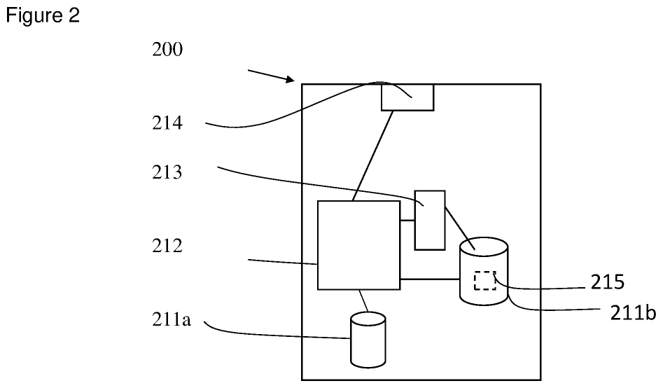

FIG. 2 illustrates an example of a control apparatus 200 for controlling a function of the 5G-AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus.

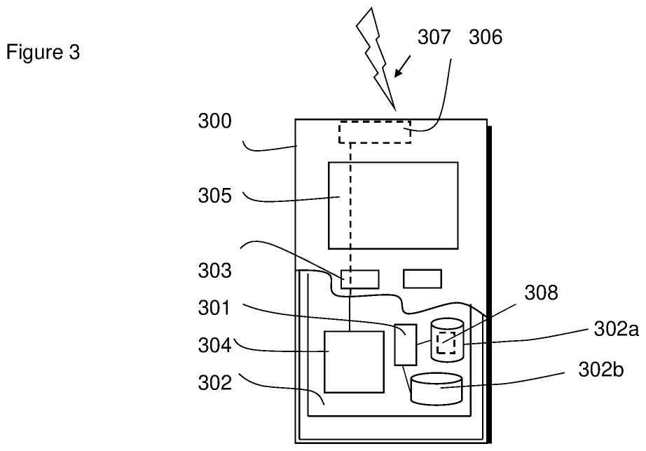

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

One or more of the following examples are applicable to personal internet-of-things networks (PIN). A PIN is a network (e.g. home automation, gaming, enterprise infrastructure etc.) of devices that may, or may not, have 3GPP UE capabilities and communicate with a data network via a gateway (GW). A PIN is configured to manage a group of at least one PIN Element with Gateway Capability (PEGC) and one or more PIN elements (PINEs) that are able to communicate each other and with 5G network via the PEGC. A user equipment may be configured as a PEGC UE. Each PINE in the PIN is a device that can communicate within a PIN, via: direct connection to the other PINE, the PEGC, or outside the PIN via a PEGC. A PIN direct connection is a connection between two PIN Elements without any 3GPP RAN or core network entity in the middle e.g. over a Zigbee or a Bluetooth connection. The PEGC is a PIN element with the ability to provide connectivity to and from the 5G network for other PINEs. The PEGC may provide a relay for communications between PINEs. A PIN may also comprise one or more PIN elements with management capability (PEMC). The PEMC is a PIN element with the capability to manage the PIN. In some systems, a PIN element can have both PIN management capability and gateway capability.

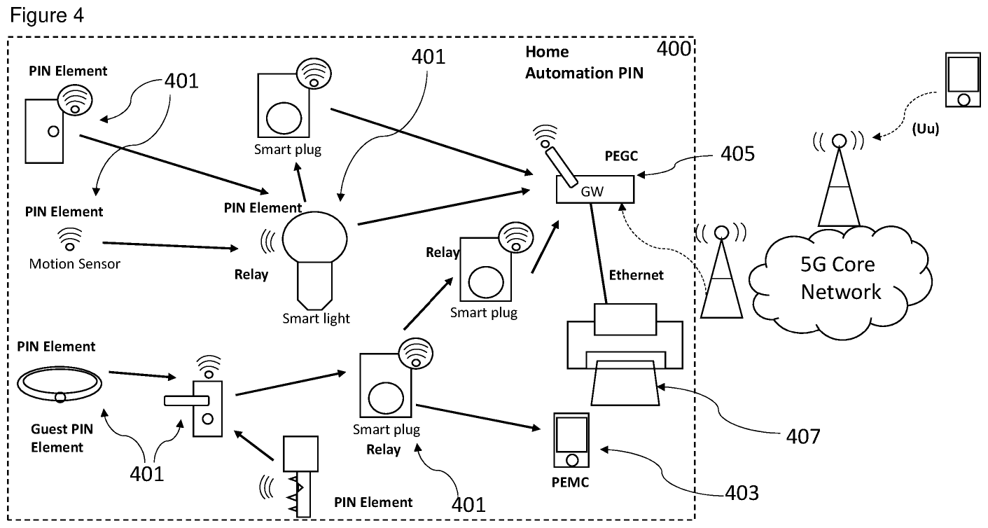

FIG. 4 shows a schematic representation of an example personal internet-of-things network (PIN) 400. In this example, the PIN 400 is a home automation PIN. In other examples, the PIN may comprise other types of devices.

In this example, the PIN 400 comprises a plurality of PINEs 401. The PINEs 401 may include a smart doorbell, a motion sensor, a smart bulb and a smart plug, as seen in FIG. 4. There is also provided a PEMC 403. The PEMC may be configured to manages each component of the PIN 400. The PIN 400 further comprises a PEGC 405. The PEGC 405 may be a UE. In other examples, the PEGC 405 is another suitable device with gateway capabilities, such as for example a wireline residential gateway.

Each of the PINEs 401 is able to communicate with the PEGC 405. Some of the PINEs 401 are able to directly communicate with the PEGC 405. Other of the PINEs are able to communicate with the PEGC 405 via a relay device. Many of the PINEs are configured as relay devices, such that PINEs 401 can communicate with the PEGC 405 via the relay PINE.

Other devices 407 may be connected to the PEGC, such as for example, a printer device. The device 407 may be connected via an ethernet connection, for example.

The PEGC 405 is able to communicate with a 5G core network 409. The PEGC 405 may communicate with the 5GC 409 via a suitable wireless connection. Any data traffic provided by PINEs 401 of the PIN will be transmitted to the 5GC 409 via the PEGC 405.

The devices of the PIN 400 may be IoT devices or non-3GPP devices acting as PINEs 401, and may be, for example, smart plugs, smart watches, smart pet collars, earbuds, VR goggle headsets, etc. that are usually connected to a PEGC UE 405 via non-3GPP access. Examples of non-3GPP access include a wireless local area network (WLAN), and Bluetooth. When the PEGC UE 405 moves, the PIN 400 moves with the PEGC UE 405 and the associated PINEs 401. There may also be other IoT devices, or non-3GPP devices, which are usually stationary connected to an evolved residential gateway (eRG) using non-3GPP access (WLAN, wireline). Examples of stationary devices include media servers, printers, smart thermostats, smart sprinklers, smart blinds, smart garages, etc.

In examples, when an application running on a PINE 401 requests a UE for uplink (UL) data traffic, the UE may perform two steps:

Firstly, the UE processes UE route selection policy (URSP) rules to decide how to route the application data traffic. The UE will try to match the information received from the application with traffic descriptors in the URSP rules. For a URSP rule with a matching traffic descriptor, the UE selects a valid route selection descriptor (RSD) associated with the USRP rule. The UE then checks if there is an existing protocol data unit (PDU) session matching the RSD, and uses the same PDU session for the application data traffic. If there is not a suitable PDU session, then the UE establishes a new PDU session for the application data traffic.

Secondly, when the application data traffic is associated with a PDU session (new or existing), then the UE performs quality of service (QOS) mapping using QoS rules. The QoS rules may be provided to the UE by a core network entity (e.g. SMF).

However, the first part of the mechanism above does not work for a PIN element with GW capability (PEGC) UE in the PIN. A PEGC UE acts as a Gateway function for PIN Elements (PINE) devices in a PIN. This is because a PINE behind the PEGC may run applications that have different routing and policy control requirements. For example, the PEGC UE may need to use one data network name (DNN), and/or one single network slice assistance information (S-NSSAI) for a set of PINEs behind the PEGC and different DNN, S-NSSAI for another set of PINEs. It should be understood that the language ‘behind’, in the context of PINEs and the PEGC, means that the PINE is connected to the 5G network via the PEGC. The PEGC is acting as a gateway or relay for the PINEs to the network.

Traffic descriptors in each URSP rule are used by the UE in order to uniquely identify the application data traffic. In current systems, the URSP rules support the components in the traffic descriptor shown below, in Table 1:

TABLE 1
Description of ‘traffic descriptors’ which are part of URSPs.

| Traffic descriptor name | Description |
|---|---|
| Application descriptors | It consists of OSId and OSAppId(s). |
| IP descriptors | Destination IP 3 tuple(s) (IP address or IPv6 network |
| | prefix, port number, protocol ID of the protocol above |
| | IP). |
| Domain descriptors | FQDN(s) or a regular expression which are used as a |
| | domain name matching criteria |
| Non-IP descriptors | Descriptor(s) for destination information of non-IP |
| | traffic |
| DNN | This is matched against the DNN information provided |
| | by the application. |
| Connection Capabilities | This is matched against the information provided by a |
| | UE application when it requests a network connection |
| | with certain capabilities. |

Each URSP rule comprises a traffic descriptor (containing one or more components described in Table 1) that determines when the URSP rule is applicable. A URSP rule is determined to be applicable when a component in the traffic descriptor matches the corresponding information from a requesting application. A URSP rule is determined not to be applicable when for any given component in the Traffic descriptor: no corresponding information from the application is available, or the corresponding information from the application does not match any of the values in the traffic descriptor component.

It has been identified that the current components of traffic descriptors of URSP rules do not provide a mechanism to identify an application running on a PINE device behind a PEGC UE. For example, the application descriptors (see Table 1) identify the application running on the UE based on ‘AppId’ and ‘OSId’. However, these descriptors do not provide any information about the application running on the PINE behind the PEGC UE. The DNN, IP/Non-IP/Domain descriptors may be provided to determine destination information that could be used to identify application traffic, but this is not sufficient to uniquely identify the application in (or running on) the PINE behind the PEGC UE, Alternatively, the PINE may not (or cannot) provide such information as the goal is to use an ‘off the shelf’ PINE device i.e. to not mandate changes to the interface between the PINE and the PEGC to carry e.g. the DNN. For example, there could be multiple PINEs using the same DNN or the same server, but each PINE may need to be treated differently by the network. For example, different PINEs may use different network slices. Furthermore, in a large PIN network, it may not be possible for the network to identify all of the destination IPs/domains and to configure it in the traffic descriptor of the URSP rules in order to uniquely identify applications running on the PINEs. It may be cumbersome for a network operator to know, in advance, all of the destination addresses of the data traffic for each different PINE, while the type of PDU Session to use may be related to the type of PINE device and not to the destination addresses of their traffic. For example, a video monitoring camera may require a low latency related PDU Session regardless of the destination of its traffic.

Therefore, PEGC UE cannot determine how to route traffic from an application running on a PINE device behind the PEGC UE, as the PEGC UE cannot uniquely identify the PINE application traffic.

One or more of the previously discussed problems are addressed in the examples as follows.

In examples, there is provided an enhanced URSP rule structure which includes a new component in the traffic descriptor components of URSP rules. This new component is configured such that it comprises information which refers to devices (e.g. PINEs) that are served by the UE (for which the UE acts as a relay or Gateway), allowing traffic descriptors of the URSP rules to target data traffic from specific devices. This will be described in more detail below.

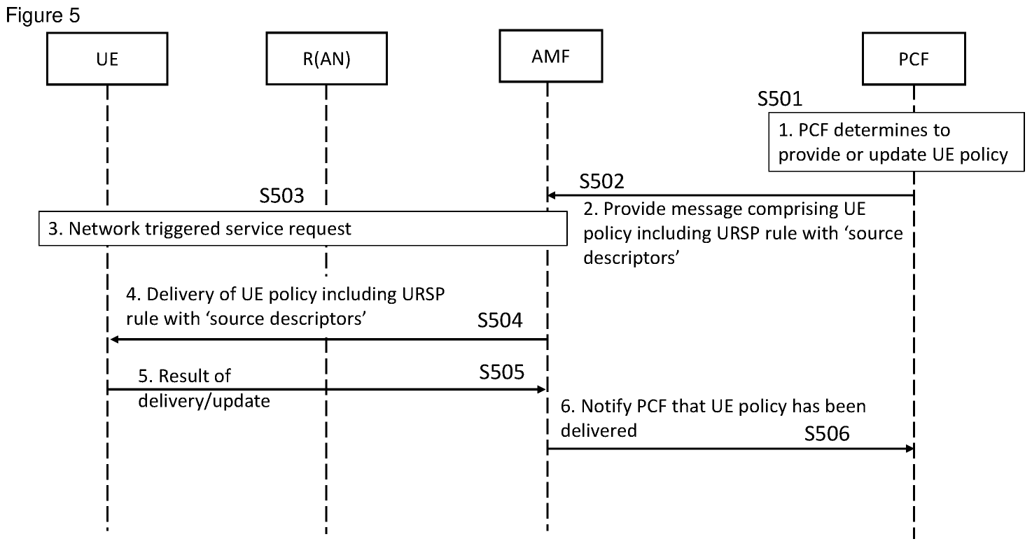

FIG. 5 shows an example signalling diagram between a user equipment and network entities. The network entities include a RAN, an AMF and a PCF. In this example, the UE may be configured as a PEGC for a PIN.

In S501, the PCF determines that a UE policy is to be provided to a UE. In some examples, the UE is already configured with a UE policy. In this case, the PCF will be updating the UE policy at the UE

The PCF may decide to update the UE policy based on triggering conditions such as an initial registration, registration with 5GS when the UE moves from EPS to 5GS, or a need for updating UE policy.

In S502, the PCF provides a message, to the AMF, comprising UE policy information that has been determined by the PCF.

In examples, the message from the PCF to the AMF may be a ‘Namf_Communication_N1N2Message Transfer’ message.

In examples, the UE policy information is comprised within a UE policy container. The UE policy container may include a list of policy sections. A policy section is identified by a policy section identifier (PSI) and comprises of one or more URSP rule(s).

The UE policy information comprises at least one URSP rule that comprises a component with information associated with a source device that is able to request for data traffic. The request for data traffic being via the user equipment (i.e. the user equipment is configured as a gateway/relay). This component may be referred to as a ‘source descriptor’. In other examples, other suitable names are used. The ‘source descriptor’ may be a traffic descriptor component. In some examples, the UE policy information comprises a plurality of URSP rules, wherein each URSP rule comprises a ‘source descriptor’ which has an identity associated with requests for data traffic via the user equipment.

In this way, the URSP rules support the following components in the traffic descriptors as shown below, in Table 2:

TABLE 2
Extended list of ‘traffic descriptors’ which are part of URSPs.

| Traffic descriptor | |
|---|---|
| name | Description |
| Application | It consists of OSId and OSAppId(s). (NOTE 2) |
| descriptors | |
| IP descriptors | Destination IP 3 tuple(s) (IP address or IPv6 network prefix, |
| | port number, protocol ID of the protocol above IP). |
| Domain descriptors | FQDN(s) or a regular expression which are used as a |
| | domain name matching criteria |
| Non-IP descriptors | Descriptor(s) for destination information of non-IP traffic |
| DNN | This is matched against the DNN information provided by |
| | the application. |
| Connection | This is matched against the information provided by a UE |
| Capabilities | application when it requests a network connection with |
| | certain capabilities. |
| Source descriptors | This defines (source) device (e.g. PINE) that is requesting |
| | the traffic. The source descriptor may include one or more |
| | of the below information: |
| | - Identity of a device (e.g. PINE) behind the GW UE (PEGC) |
| | (e.g. MAC address, source IP address/port number, |
| | Bluetooth ID, Zigbee ID, or any other unique identifier given |
| | to the second device , such a network access identifier |
| | (NAI) received by the GW UE (PEGC) equipment once the |
| | device has been authenticated). This identity of the device |
| | may be received by the UE (i.e. PEGC) during the |
| | authentication of the PINE and/or connection establishment |
| | procedure between the PINE and PEGC . |
| | - Identity of a PIN (or the network) of the device (e.g. a |
| | service set identifier (SSID) of the access point supported |
| | by the UE acting as GW, or any other unique identifier |
| | assigned to the PIN or the network) |

It is noted that the GW UE may correspond to different types of devices such as a smartphone. In other examples, the GW UE is a wireline residential gateway. In other examples, the GW UE is any suitable device configured as a gateway.

In S503, there is a network triggered service request between the UE and AMF, via the RAN. In S503, the AMF attempts to reach the UE. If the UE is registered and reachable by AMF, in either 3GPP access or non-3GPP access, then the AMF is able to transfer (transparently) the UE policy information to the UE via the registered and reachable access.

In S504, the AMF provides the UE policy information comprising the at least one URSP rule with a ‘source descriptor’ to the UE. In examples, the UE policy information is provided within a UE policy container, wherein the UE policy container includes a list of policy sections.

In S505, in response to receiving the UE policy information from the AMF, the UE updates the UE policy (at the UE). The UE will then provide a result of the update to the AMF.

In S506, if the AMF received the UE policy information (in S502) and the PCF subscribed to be notified of the reception of the UE policy information, then the AMF forwards the result from the UE (of S505) to the PCF. The AMF may provide the response message to the PCF using ‘Namf_Communication_N1MessageNotify’.

Once the UE has been configured with the UE policy information (S505), this means that the UE as PEGC is able to route data traffic from PINEs behind the UE. For example, the UE may receive, from an application of a device (e.g. a PINE), a request for uplink data traffic. In this way, the UE and the device (that provides the request) are separate devices. The request comprises information about the application and/or the requesting device. The UE will then determine how to route the data traffic from the application, using the at least one URSP rule of the UE policy information based on the received information about device (e.g. a PINE), to determine a route. In this way, the UE utilises both the at least one URSP rule and the received information about the device to determine the route. The UE then routes the data traffic from the application according to the determined route.

In some examples, the at least one URSP rule comprises a plurality of URSP rules in the UE policy information. Each of the URSP rules may have a ‘source descriptor’ which identifies a PINE/PIN.

As an example only, to aid understanding, the UE (or other gateway device) may be configured with three URSP policies. URSP policy 1: if data traffic comes from a device at MAC address XYZ (wherein MAC address XYZ is associated with PINE #1), then use route 1. URSP policy 2: if data traffic comes from a device at MAC address ABC (wherein MAC address ABC is associated with PINE #2) and is targeting IP address C.D.E.F then use route 2. URSP policy 3: Otherwise for any other relayed traffic use route 3. In this way, the ‘source descriptor’ traffic descriptor, and the ‘IP descriptor’ from Table 2, in URSP rules, may be used in combination in some examples. For example, the URSP enhancement in Table 2 enables a combination of source device (address/identifier) and target IP address of the UL traffic, in a URSP rule. In other examples, URSP rules may use other combination of traffic descriptors.

When the UE is determining how to route the data traffic (for the requesting application), the UE may compare/match the received information about the device (from the request for UL data traffic) with the ‘source descriptors’ of each of the plurality of URSP rules (i.e. the information of an identity). The applicable URSP rule of the plurality of URSP rules will be the URSP rule that matches the information about the application. In this way, the UE selects the applicable URSP rule for the received request.

Each of the URSP rules may comprise a route selection descriptor (RSD). The UE may utilise the RSD of the determined URSP rule in order to determine the route for the data traffic.

When the UE has determined the applicable URSP rule and associated RSD, then the UE may determine whether there is an existing PDU session that has been established and matches the RSD. If there is an existing PDU session matching the RSD, then the UE may utilise the PDU session for routing the data traffic. In other examples, when there is not an established PDU session, then the UE will establish a new PDU session. Following this, the UE may perform QoS mapping, for the PDU session (whether new or pre-established), using at least one QoS rule. The QoS rules may have been provided to the UE via an SMF. In other examples, the QoS rules are provided via other suitable NFs.

The ‘source descriptor’ (as a traffic descriptor) contains information of an identity of a device that is using the UE (acting as PEGC) as a gateway to access the data network via 5GS. Additionally the ‘source descriptor’ may also comprise network information (such as an SSID) of where the data traffic is received.

The “source descriptor” may contain one or more of the below information:
i) a unique identity of a device that is using the UE as a gateway. The unique identity may comprise a medium access control (MAC) address of the device. The unique identity may comprise a source internet protocol (IP) address/port. The unique identity may comprise a Bluetooth identity. In other examples, the unique identity may comprise any unique identifier given to the PINE within the PIN. The unique identity of the device may be received by the UE during the authentication of the PINE. In this way, the unique identity of the device will be known to the UE.
ii) An identity of the PIN. The identity of the PIN may comprise a service set identifier (SSID) of an access point supported by the PEGC UE. The identity of the PIN may comprise any other unique identifier used to identify the PIN. In some examples, URSP rules can be provided for PIN solely. For example, if the PEGC UE is used for different PINs and data traffic from different PIN is routed differently, then there may be no need to identify the PINE (identifying the PIN in the source descriptor is sufficient).
iii) Any other information that uniquely identifies a PIN and/or a PINE and/or a device that is using the UE as a GW (PEGC).
iv) Any other information that uniquely identifies an application running on a PINE (or a device) behind the UE acting as a GW (PEGC).

For the signalling provided in FIG. 5, it is assumed that the PCF has the information available to include the “source descriptor” information in the traffic descriptor of the URSP rules for a GW (PEGC) UE. The information may be made available to the PCF via provisioning in the UDR as part of UE policy. In other examples, the information may be made available to the PCF by an application function (AF) using the mechanisms of providing “Application guidance for URSP determination” to the PCF. In this example, the AF represents a user managing the PIN: via this AF the user can manage the PIN and associate the PIN or PINE with dedicated DNNs/S-NSSAIs offered by the operator.

Some UEs from older releases may not support the ‘source descriptor’ as a traffic descriptor component in URSP rules. It may be advantageous for the network to know whether certain UEs support the ‘source descriptor’ or not.

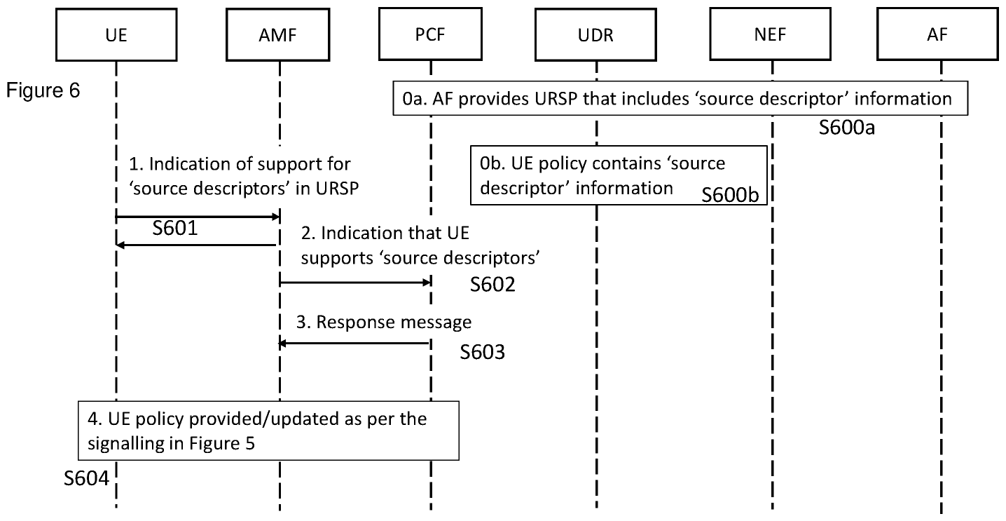

FIG. 6 shows another example signalling diagram between a user equipment and network entities. In this example, the UE communicates with an AMF, a PCF, a UDR, an NEF, and an AF.

In S600a, the AF provides, to the PCF, at least one URSP that includes ‘source descriptor’ information.

In S600b, at the UDR, a UE policy comprises ‘source descriptor’ information.

In S601, the UE provides an indication to the AMF that the UE supports the ‘source descriptor’ traffic descriptor in URSP rules. The indication may be provided in a registration request message. The UE may receive a response message from the AMF.

In examples, the indication may be an indirect indication. For example, the UE may indicate that it is a PEGC UE.

In S602, the AMF forwards the indication to the PCF. The indication may be forwarded to the PCF during a UE policy establishment procedure. With this indication, PCF is aware that the PCF may include a ‘source descriptor’ in traffic descriptors of the URSP rules. The PCF may include the ‘source descriptors’ based on the UE's policy subscription data, and/or “AF guidance for URSP determination”.

In S603, the PCF provides a response message to the AMF.

In S604, following the indication being provided in S602, the PCF may determine that a UE policy is to be provided to the UE. This may be an update procedure if the UE is already configured with a UE policy. This will trigger the signalling as shown in FIG. 5.

The signalling of FIG. 6 means that a UE is able to provide an indication of support for the new URSP capability of ‘source descriptors’ in a message (e.g. registration request) to the AMF. The AMF includes the UE indication in a UE policy control establishment request to the PCF. The PCF then decides to provide at least one URSP rule containing the new ‘source descriptor’ traffic descriptor, based on the UE policy information that is available to it (assuming that the indication from the UE is that the UE supports the new URSP traffic descriptor component.)

One or more of the examples above allows a UE (configured as a PEGC) to determine how to route data traffic from an application running on a PINE device behind the UE in an efficient manner. The data traffic may be routed from the PINE such that the fewest resources are used. The data traffic may be routed from the PINE such that QoS rules are adhered to. The data traffic may be routed such that the correct DNN and/or S-NSSAI is used for the PINE that is requesting the UL data traffic. Furthermore, the network knows whether certain UEs can support the ‘source descriptor’ component in URSP rules. In this way, the network knows not to provide URSP rules with ‘source descriptors’ to UEs that do not support it. This saves resources at the network by not making transmissions from the network to UEs unnecessarily.

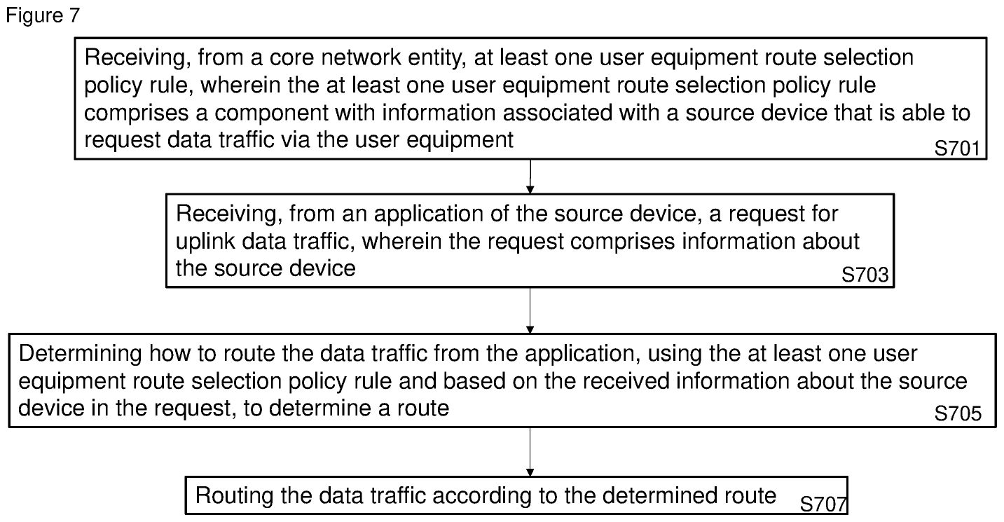

FIG. 7 shows an example method flow performed by an apparatus. The apparatus may be comprised within a user equipment. The apparatus may be comprised within a terminal. The apparatus may be comprised within a device configured as a gateway. The apparatus may be comprised within a PEGC.

In S701, the method comprises receiving, from a core network entity, at least one user equipment route selection policy rule, wherein the at least one user equipment route selection policy rule comprises a component with information associated with a source device that is able to request data traffic via the user equipment.

In S703, the method comprises receiving, from an application of the source device, a request for uplink data traffic, wherein the request comprises information about the source device.

In S705, the method comprises determining how to route the data traffic from the application, using the at least one user equipment route selection policy rule and based on the received information about the source device in the request, to determine a route.

In S707, the method comprises routing the data traffic according to the determined route.

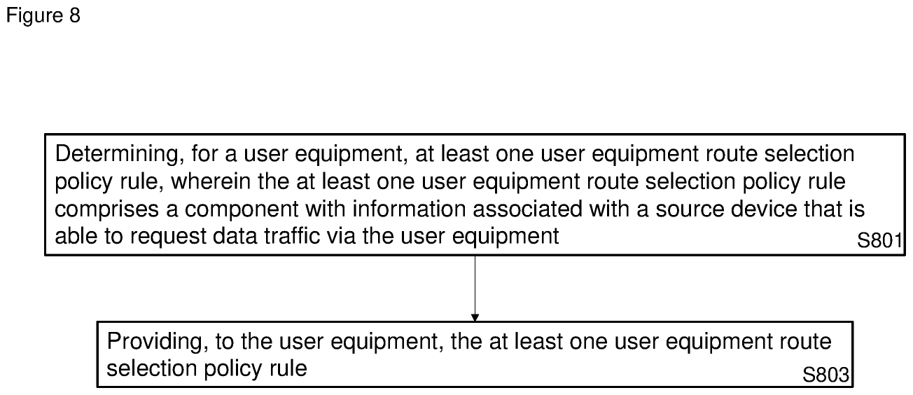

FIG. 8 shows an example method flow performed by an apparatus. The apparatus may be comprised within a core network entity. The apparatus may be comprised within a network function. The apparatus may be comprised within a PCF.

In S801, the method comprises determining, for a user equipment, at least one user equipment route selection policy rule, wherein the at least one user equipment route selection policy rule comprises a component with information associated with a source device that is able to request data traffic via the user equipment.

In S803, the method comprises providing, to the user equipment, the at least one user equipment route selection policy rule.

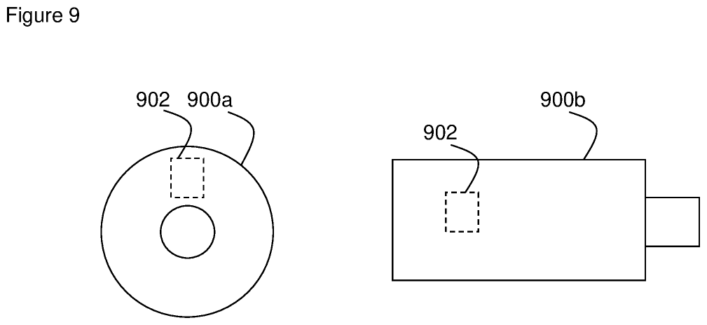

FIG. 9 shows a schematic representation of non-volatile memory media 900a (e.g. computer disc (CD) or digital versatile disc (DVD)) and 900b (e.g. universal serial bus (USB) memory stick) storing instructions and/or parameters 902 which when executed by a processor allow the processor to perform one or more of the steps of the methods of FIG. 7 or FIG. 8.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following: (a) hardware-only circuit implementations (such as implementations in only analogue and/or digital circuitry); (b) combinations of hardware circuits and software, such as: (i) a combination of analogue and/or digital hardware circuit(s) with software/firmware and (ii) any portions of hardware processor(s) with software (including digital signal processor(s)), software, and memory (ies) that work together to cause an apparatus, such as the communications device or base station to perform the various functions previously described; and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1-23. (canceled)

24. An apparatus in a user equipment, the apparatus comprising: at least one processor; and at least one memory storing instructions that, when executed by the at least one processor, cause the apparatus at least to perform:
receiving, from a core network entity, at least one user equipment route selection policy rule, wherein the at least one user equipment route selection policy rule comprises a component with information associated with a source device;
receiving, from an application of the source device, a request for uplink data traffic, wherein the request comprises information about the source device;
determining how to route the data traffic from the application, using the at least one user equipment route selection policy rule and based on the received information about the source device in the request, to determine a route; and
routing the data traffic according to the determined route.

25. The apparatus according to claim 24, wherein, for the at least one user equipment route selection policy rule, the information associated with the source device comprises at least one of:
an identity of at least one source device;
an identity of a network associated with the user equipment

26. The apparatus according to claim 25, wherein at least one of:
the identity of the source device is an identity of a personal internet-of-things network element; and
the identity of the network is an identity of a personal internet-of-things network.

27. The apparatus according to claim 25, wherein the identity of the source device comprises at least one of: a medium access control address, a source internet protocol address, a port number, a bluetooth identity, a unique identification of the personal internet-of-things network element, a network access identifier received by the user equipment once the source device has been authenticated.

28. The apparatus according to claim 26, wherein the identity of a personal internet-of-things network comprises at least one of: a service set identifier of an access point, a unique identification of the personal internet-of-things network.

29. The apparatus according to claim 24, wherein the at least one user equipment route selection policy rule comprises a plurality of user equipment route selection policy rules

30. The apparatus according to claim 29, wherein the route is determined utilising a route selection descriptor associated with the selected user equipment route selection policy rule.

31. The apparatus according to claim 30, wherein the apparatus comprises:
determining whether there is an existing protocol data unit session that has been established and is compatible with the route selection descriptor; and
when there is an existing protocol data unit session that is compatible with the route selection descriptor, utilising the protocol data unit session for routing the data traffic.

32. The apparatus according to claim 31, wherein the apparatus comprises:
performing quality of service mapping, for the protocol data unit session, using at least one quality of service rule.

33. The apparatus according to claim 24, wherein the apparatus comprises:
providing an indication, to a further core network entity, that the user equipment supports user equipment route selection policy rules with components that have information associated with a source device that is able to request data traffic via a user equipment.

34. The apparatus according to claim 33, wherein the indication is provided to the further core network entity within a registration request message.

35. An apparatus for a core network entity, the apparatus comprising: at least one processor; and at least one memory storing instructions that, when executed by the at least one processor, cause the apparatus at least to perform:
determining, for a user equipment, at least one user equipment route selection policy rule, wherein the at least one user equipment route selection policy rule comprises a component with information associated with a source device that is able to request data traffic via the user equipment; and
providing, to the user equipment, the at least one user equipment route selection policy rule.

36. The apparatus according to claim 35, wherein, for the at least one user equipment route selection policy rule, the information associated with the source device comprises at least one of:
an identity of at least one source device;
an identity of a network associated with the user equipment.

37. The apparatus according to claim 36, wherein at least one of:
the identity of the source device is an identity of a personal internet-of-things network element; and
the identity of the network is an identity of a personal internet-of-things network.

38. The apparatus according to claim 36, wherein the identity of the source device comprises at least one of: a medium access control address, a source internet protocol address, a port number, a bluetooth identity, a unique identification of the personal internet-of-things network element, a network access identifier received by the user equipment once the source device has been authenticated.

39. The apparatus according to claim 38, wherein the identity of a personal internet-of-things network comprises at least one of: a service set identifier of an access point, a unique identification of the personal internet-of-things network.

40. The apparatus according to claim 35, wherein the determining comprises determining the at least one user equipment route selection policy rule based on a received input from an application function, wherein the application function is associated with a personal internet-of-things network associated with the user equipment device.

41. The apparatus according to claim 35, wherein the apparatus comprises:
receiving an indication, from the user equipment, that the user equipment supports user equipment route selection policy rules with components that have information associated with a source device that is able to request data traffic via a user equipment.

42. The apparatus according to claim 35, wherein the apparatus comprises:
using the received indication to trigger the determination of the at least one user equipment route selection policy rule which comprises the component with information associated with the source device that is able to request data traffic via the user equipment.

43. A method performed by a user equipment, the method comprising:
receiving, from a core network entity, at least one user equipment route selection policy rule, wherein the at least one user equipment route selection policy rule comprises a component with information associated with a source device that is able to request data traffic via the user equipment;
receiving, from an application of the source device, a request for uplink data traffic, wherein the request comprises information about the source device;
determining how to route the data traffic from the application, using the at least one user equipment route selection policy rule and based on the received information about the source device in the request, to determine a route; and
routing the data traffic according to the determined route.
